(19) United States
(12) Patent Application Publication
(10) Pub. No.: US 2009/0058249 A1
(43) Pub. Date: Mar. 5, 2009

(54) Ultraviolet ray light source apparatus

(75) Inventor: Nozomu Tajika, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA, Tokyo (JP)

(21) Appl. No.: 12/230,865

(22) Filed: Sep. 5, 2008

(30) Foreign Application Priority Data
Sep. 5, 2007 (JP) 2007-230073

(51) Int. Cl. H01K 1/58

(52) U.S. Cl. 313/25

(57) ABSTRACT

An ultraviolet ray light source apparatus includes a discharge lamp in which a pair of electrodes are arranged inside an approximately rod shape arc tube, and a shrunk portion and a sealing portion are formed at both ends of the arc tube, a cooling jacket in which a lamp configuration space extending in parallel with the arc tube and is formed in a light emission section area of the discharge lamp, and a pair of lamp holders which supports the discharge lamp in the lamp configuration space, so that an axis of the arc tube is horizontally supported. The ultraviolet ray light source apparatus further comprises a cooling unit which sends cooling air toward an upper part of the shrunk portion at an end of the arc tube and a discharge section, provided below the shrunk portion, which discharges the cooling air.

### CROSS-REFERENCES TO RELATED APPLICATION

The disclosure of Japanese Patent Application No. 2007-230073, filed Sep. 5, 2007, including its specification, claims and drawings, is incorporated herein by reference in its entirety.

### TECHNICAL FIELD

The present invention relates to an ultraviolet ray light source apparatus equipped with a cooling jacket in which a discharge lamp is cooled when cooling fluid flows through the inside thereof.

### BACKGROUND

By using a lamp which emits light including ultraviolet rays, curing, drying, melting, softening, reforming etc. of a protective coat, an adhesive agent, paint, ink, a resist, resin, a photo-alignment film, etc., have been widely performed in various fields. Such a lamp for emitting ultraviolet rays, which is used for these uses is, in particular, a long arc type discharge lamp, such as a high-pressure mercury lamp, a metal halide lamp etc., in which a high optical output can be obtained. A pair of electrodes which face each other is arranged inside a rod shape arc tube of the discharge lamp, and also light-emitting material which emits light having a predetermined emission spectrum, and mercury if needed, is enclosed therein.

In the above mentioned discharge lamp, it is required that light be irradiated with a high output to a work piece. In order to raise an input electric power applied to the lamp, the discharge lamp is placed inside an approximately cylindrical cooling jacket which has ultraviolet-ray permeability, so as to use it as an ultraviolet ray light source apparatus (for example, see Japanese Laid Open Patent No. 61-158453). In case where the ultraviolet ray light source apparatus is used without the cooling jacket for cooling, since the temperature of the arc tube reaches 1,000 degrees Celsius or more when the normal lamp power is inputted, the arc tube is overheated so that the function of the lamp may not be obtained. Therefore, it is necessary to make the lamp input small. However, by using the cooling jacket, it is possible to make the temperature of the arc tube lower than that of a lamp without cooling or that of a lamp having only an air cooling means, so that a large electric power can be applied therein, whereby a high ultraviolet-rays output can be realized.

FIG. 6A is an explanatory cross sectional view of an ultraviolet ray light source apparatus of the prior art technology, taken along the lamp tube axis thereof. FIG. 6B is a cross sectional view thereof, taken along a line 6B-6B of FIG. 6A. In addition, in explanation set forth below, since a cooling jacket is a water cooled system merely as an example, the cooling jacket is hereinafter simply referred to as a water-cooled jacket. A main body of the water-cooled jacket 70 has a double pipe type structure in which an outer pipe 711 and an inner pipe 712 are approximately coaxially arranged, and in which water passes through as cooling fluid between the outer pipe 711 and the inner pipe 712. In this figure, the cooling water, is introduced through an inflow pipe 72 connected to one end side of the outer pipe 711, passes through between the outer pipe 711 and the inner pipes 712 (toward a right lower side in the figure), and is discharged from a discharge pipe 73 connected to the other end side thereof. The outer pipe 711 and the inner pipe 712 are made of quartz glass which has permeability to ultraviolet rays. The cooling water is usually demineralized water (pure water).

The cylindrical discharge lamp 10 is inserted in a lamp configuration space S which is formed in the inside of the inner pipe 712 of the water-cooled jacket 70, and is held by lamp holders 80A and 80B at the hollow center. In addition, vent holes 81 are formed in the lamp holders 80A and 80B and cooling air flows in a direction shown in arrows. Thus, the cooling air passes through the lamp configuration space S in parallel with the tube axis of a lamp 10 (See Japanese Laid Open Patent No. 6-267512).

Heat of the discharge lamp 10 conducts to the inner wall of the water-cooled jacket 70, through an air layer between the arc tube 11 and the inner pipe 712 of the lamp configuration space S, and is cooled down with the cooling water which passes inside the water-cooled jacket 70. Thus, although the cooling water which flows inside the water-cooled jacket 70 prevents the lamp from being overheated, since the cooling is performed in an indirect manner in which the air layer exists therebetween, the temperature of the arc tube 11 does not result in a supercooling state where the material enclosed in the arc tube 11, such as mercury, remains un-evaporated so that the light emission section is maintained to a suitable temperature.

FIG. 5 is a cross sectional view of an example of the structure of a discharge lamp for an ultraviolet ray light source which is used in general, taken along an tube axis thereof. An arc tube 11 in this figure is made of quartz glass, and a pair of electrodes 13A and 13B is arranged apart from each other at a predetermined distance. Internal lead rods 14A and 14B are provided so as to be connected to the electrodes 13A and 13B, respectively. The internal lead rods 14A and 14B are respectively connected to metallic foils 15A and 15B made of molybdenum. Sealing portions 12A and 12B are airtightly formed by welding the metallic foil 15A and 15B and the glass of the arc tube 11, respectively. When electric discharge occurs between the electrode 13A and 13B, the mercury, which is enclosed as a light-emitting material in the arc tube 11, evaporates, so that ultraviolet rays of the bright line spectrum of mercury are emitted. The ultraviolet rays go through the inner pipe 712 of the water-cooled jacket 70, the cooling water, and the outer pipe 711, and are emitted to the outside thereof, so as to be irradiated on a work piece.

It is said that the water-cooled jacket of the ultraviolet ray light source apparatus has two functions as set forth below.

(1) The first one is a function of maintaining the arc tube in a suitable temperature by cooling the lamp when the lamp is lit. In order that the enclosed mercury and other metallic compounds may evaporate in the arc tube of the discharge lamp at the time of lighting, it is necessary to warm it at 500 degrees Celsius or more. If the temperature of the arc tube becomes less than 500 degrees Celsius, non-evaporated enclosed material appears, so that predetermined ultraviolet-rays radiation can not be obtained. On the other hand, if the arc tube temperature becomes high temperature exceeding 900 degrees Celsius, the quartz glass which forms the arc tube is recrystallized, so that devitrification may occur, whereby an ultraviolet-rays output is reduced. Therefore, it is said that it is appropriate to maintain the temperature in a range of 500-900 degrees Celsius.

(2) The second one is a function of making thermal influence on a work piece small. The cooling water cools down the radiant heat of the arc tube, thereby making the thermal influence on the work piece small. Moreover, the cooling water absorbs light components, i.e. light ranging from visible light to infrared rays, which are included in the light emitted from the lamp, and are unnecessary in the ultraviolet processing light, so that the cooling water prevents the work piece from being heated by the light.

In such a ultraviolet ray light source apparatus, in order that the temperature at a point P which is located at a top center of the arc tube shown in FIG. 6A, may become a predetermined temperature at the time of the lamp lighting, the interval of the inner wall of the inner pipe and the outer wall of the arc tube, the temperature of the cooling water, a flow rate thereof etc. are adjusted (for example, see Japanese Laid Open Patent No. S54-99370). This is because, in the above-mentioned discharge lamp, an electric discharge arc is formed between a pair of electrodes, so that the lamp (arc tube) is warmed up. Therefore, when the lamp is lit while the tube axis of the lamp is maintained horizontally, the arc is pushed upwards by a convection in the arc tube, since the temperature of the arc tube is high at the top center point P of the light emission section, and the temperature thereof becomes lower as closer to the both ends thereof.

However, as mentioned above, even though the ultraviolet ray light source apparatus is tried to be operated so that the temperature at the top center point of the arc tube may become a predetermined value, the arc tube may be overheated more than the set-up temperature.

(1) The lamp configuration space in the water-cooled jacket is formed inside the inner pipe whose diameter is formed uniformly. Since, in the discharge lamp, the outer diameter of the arc tube in the light emission section area is constant, a gap (d) between the light emission section (between electrodes) and an inner face of the water-cooled jacket is approximately constant, so that the light emission section may be uniformly cooled. However, the diameter of end portions of the arc tube gradually becomes small in order to form the sealing portions, so that the distance between the tube wall and the inner wall of the water-cooled jacket becomes large toward the respective end portions.

(2) Since the sealing portions of the arc tube are apart from the arc, even if the cooling effect due to the water-cooled jacket is not obtained, it does not matter as much. However, in the portions near the light emission section, i.e., the diameter shrunk portions of the tube which extend from the portion near the electrodes to the sealing portions, since the distance between an arc and the portions is also small, the arc tube tends to be heated. In addition, a gap between the portions and the inner wall of the water-cooled jacket becomes large because of the shrunk portions, the cooling effect will not be obtained, but temperature thereof will become high. Therefore, even if the temperature of the light emission section in the arc tube is tried to be maintained aiming at a target temperature, in sides of the electrodes at both ends of the arc tube, the temperature of the arc tube may become higher than the target temperature. Furthermore, in an upper part of the arc tube, the temperature becomes high due to the influence of a convection, and in addition, a temperature difference between the upper part and the lower part becomes large, coupled with the cooling effect not being obtained.

From such a situation, in order to maintain the temperature of the entire arc tube to a temperature less than that at which devitrification does not occur, for example, 900 degrees Celsius, it is necessary to set up the temperature of the light emission section of the lamp so as to be far lower than 900 degrees Celsius. Therefore, it is necessary to make electric power to be applied to the lamp small. In other words, while there is sufficient room for the resistance of the arc tube, a lamp input is suppressed, and further it is necessary to make an optical output small so as to use it.

Japanese Laid Open Patent No. 6-267512 teaches that openings are formed in a lamp holder, and cooling air is made to pass through around the lamp. However, even in the prior art, since the cooling air which is warmed with the heat of the lamp passes therethrough, in the end portions of the arc tube in a side of the downstream of the cooling air, there is no cooling effect, so that it becomes the overheating state, whereby breakage and milky spots of the arc tube will be produced. Moreover, even in the art, the problem of the temperature difference between the upper part and the lower part in shrunk portions of the arc tube, has not been solved.

### SUMMARY

Therefore, subject matter to be solved by the present invention, is to offer an ultraviolet ray light source apparatus in which a discharge lamp is inserted inside an inner pipe of a cooling jacket, and is held in the hollow center, whereby it is possible to prevent the temperature of an arc tube of the discharge lamp from rising superfluously, and it is possible to prevent breakage and devitrification of the lamp and further it is possible to make electric power to be applied to the lamp, still higher

The present ultraviolet ray light source apparatus includes a discharge lamp in which a pair of electrodes are arranged inside an approximately rod shape arc tube, and shrunk portions and sealing portions are formed at both ends of the arc tube, a cooling jacket in which a lamp configuration space extending in parallel with the arc tube and is formed in a light emission section area of the discharge lamp, and a pair of lamp holders which supports the discharge lamp in the lamp configuration space, so that an axis of the arc tube is horizontally supported. Further, the ultraviolet ray light source apparatus comprises a cooling unit which sends cooling air toward an upper part of the shrunk portions, and a discharge section, provided below at least one of the shrunk portions, which discharges the cooling air.

The cooling unit may have an air distribution opening formed in the lamp holder so as to be directed to the shrunk portion of the arc tube, and a cooling air supply unit.

The discharge section is an opening formed below one of the lamp holders.

Since, compared with the light emission section, in the shrunk portion formed in the both ends of the arc tube, the distance between the tube wall of the arc tube and the inner wall of the water-cooled jacket is large, it is hard to be cooled, and these portions tend to be overheated. However, in the above-mentioned structure, even in the shrunk portions of the arc tube, since cooling air is blown from the vent holes formed in the lamp holders toward the upper parts which tend to be overheated due to the influence of a convection, the tube wall of a shrunk portion is cooled effectively, and it is possible to prevent beforehand the arc tube from causing damages or milky spots.

According to the present invention, overheating in the upper parts of the shrunk portions in both ends of the arc tube of a discharge lamp can be prevented, and in addition, the temperature difference between the upper part and the lower part of the arc tube can be made small, so that it is possible to maintain the temperature of the entire arc tube in a target temperature range, whereby breakage and devitrification of the lamp can be certainly prevented. And electric power to be applied to the lamp can be set up higher than that of the prior art apparatus, so that the optical output of ultraviolet rays can be increased further.

### BRIEF DESCRIPTION OF THE DRAWINGS

Other features and advantages of the present ultraviolet ray light source apparatus will be apparent from the ensuing description, taken in conjunction with the accompanying drawings, in which:

FIG. 1 is an explanatory cross sectional view of an ultraviolet ray light source apparatus according to the embodiment of the present invention, taken along the tube axis of a lamp;

FIG. 2 is a side elevational view of the ultraviolet ray light source apparatus of FIG. 1 which is viewed from a jacket holder side;

FIG. 3 is a perspective view which is viewed from a jacket holder side, for explaining attachment operation steps according to an embodiment of the present invention;

FIG. 4A is an explanatory view of an ultraviolet ray light source apparatus according to the example of (a) experiment, and the graph which shows the result of the example of (b) experiment;

FIG. 4B is a graph showing a result of experiment;

FIG. 5A is an explanatory cross sectional view of an example of the structure of a discharge lamp for an ultraviolet ray light source, taken along the tube axis thereof;

FIG. 5B is a cross sectional view thereof, taken along a line 5B-5B;

FIG. 6A is an explanatory view of an ultraviolet ray light source according to the prior art, taken along a plan passing through a lamp tube axis; and

FIG. 6B is a cross sectional view thereof, taken along a line 6A-6A.

### DESCRIPTION

The descriptions in the specification are provided for illustrative purposes only, and are not limiting thereto. An appreciation of various aspects of the present ultraviolet ray light source apparatus is best gained through a discussion of various examples thereof. The meaning of these terms will be apparent to persons skilled in the relevant arts based on the entirety of the teachings provided herein.

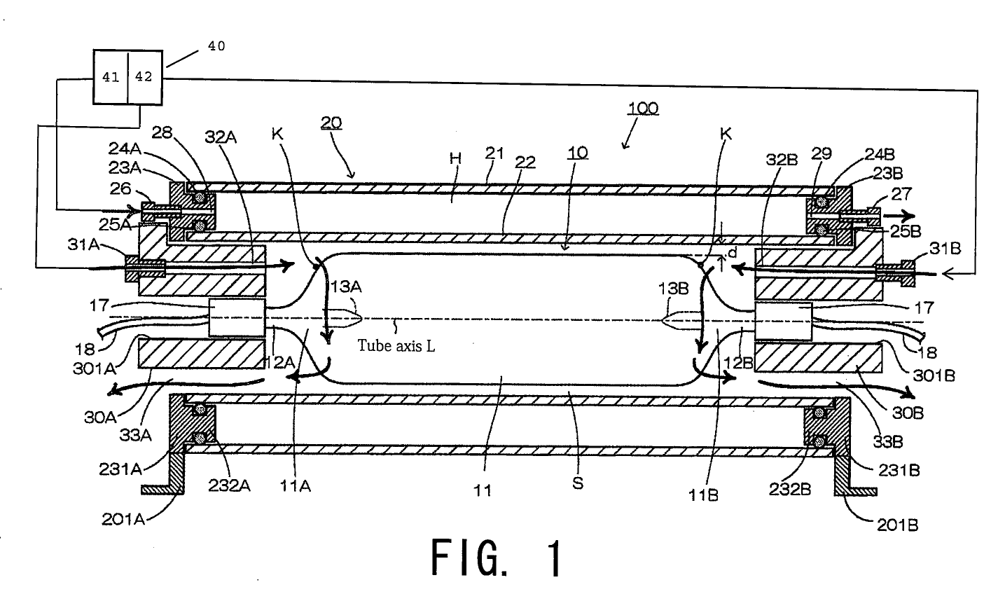

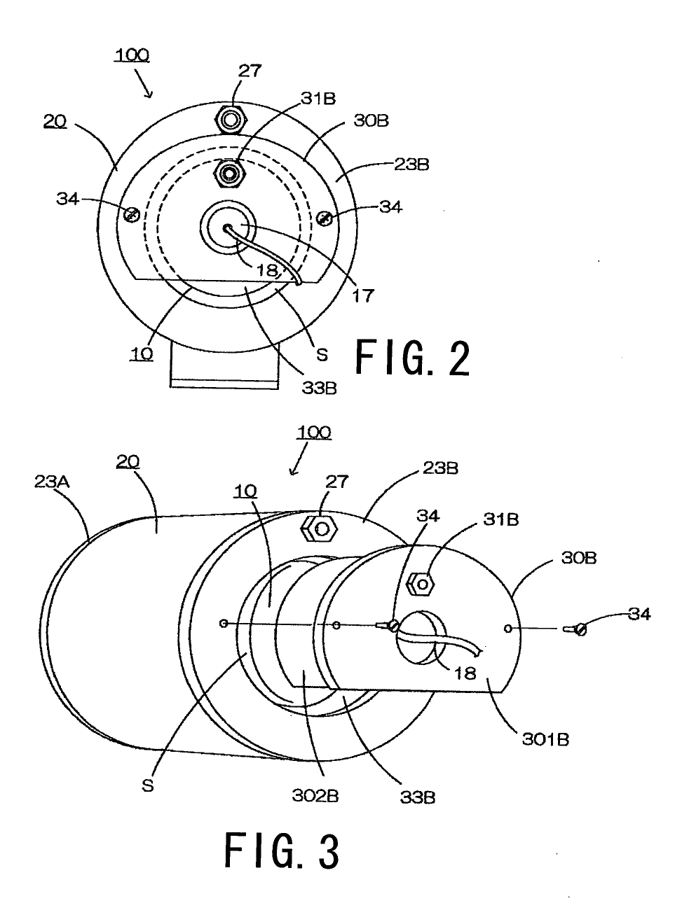

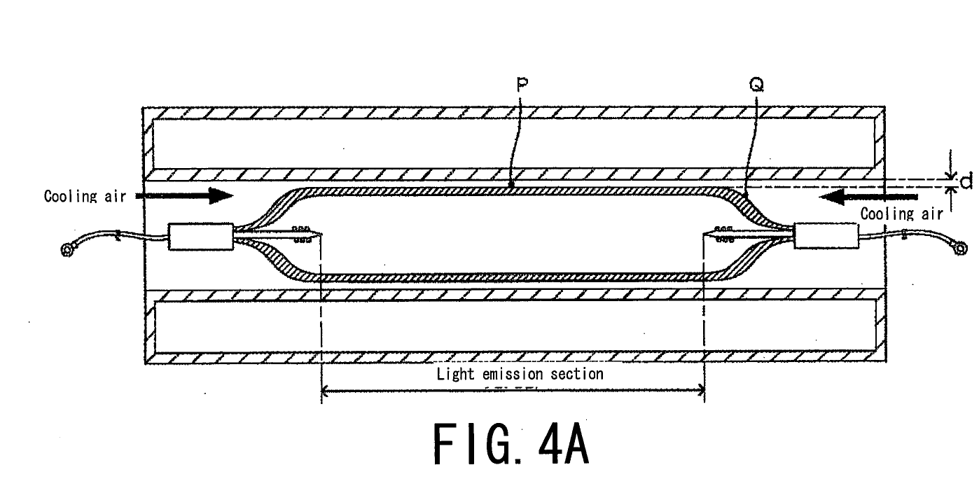

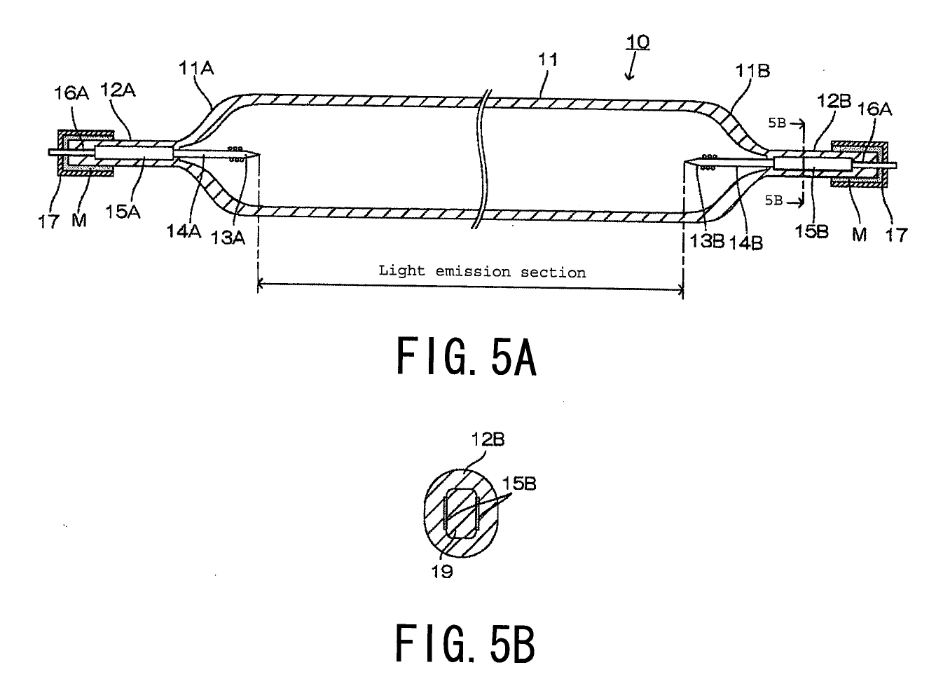

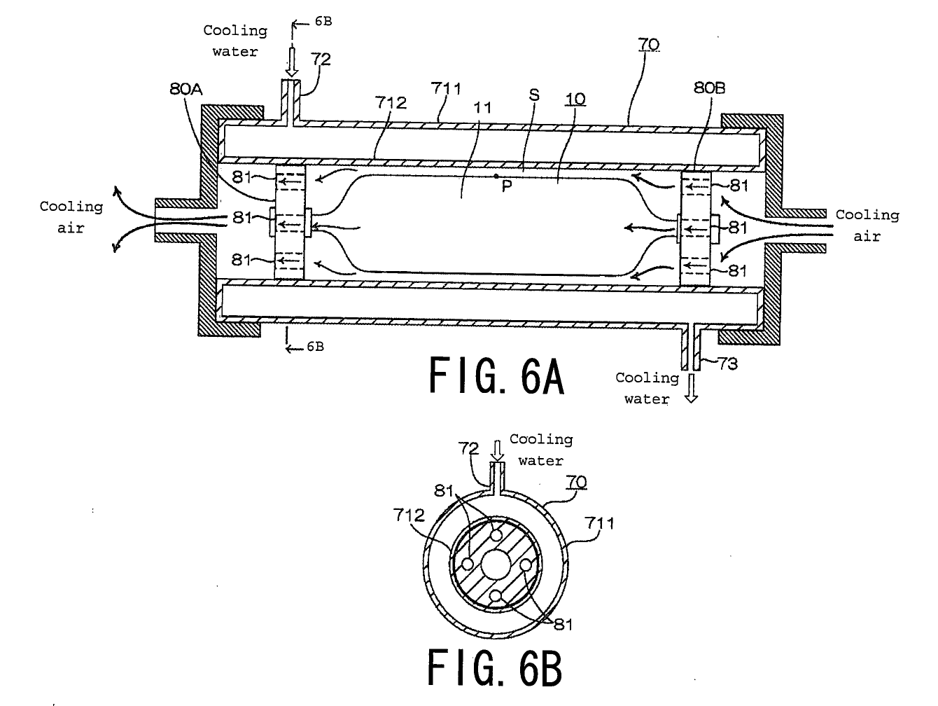

An embodiment of the present invention is described referring to figures. FIG. 1 is an explanatory cross sectional view of an ultraviolet ray light source apparatus according to the embodiment of the present invention, taken along the tube axis of a lamp. FIG. 2 is a side elevational view of the ultraviolet ray light source apparatus of FIG. 1 which is viewed from a jacket holder side. FIG. 3 is a perspective view of the ultraviolet ray light source apparatus which is viewed from the jacket holder side, and is an explanatory view for explaining attachment steps. In addition, the structure of the discharge lamp placed in the inside thereof is the same as that shown in FIG. 5, and description will be given referring to FIG. 5.

In FIGS. 1-3, a water-cooled jacket 20 comprises an outer pipe 21 and an inner pipe 22 made of quartz glass which transmits ultraviolet rays, a pair of jacket holders 23A and 24B arranged at both ends of the pipes, and O-rings 24A, 24B, 25A, and 25B are provided to maintain cooling fluid in a liquid-tight state between the jacket holders 23A and 23B. The jacket holders 23A and 23B made of, for example, aluminum, comprise base sections 231A and 231B which are in contact with end surfaces of the outer pipe 21 and the inner pipe 22 which are made of quartz glass, thereby defining the position of the pipes in the axial direction thereof, and support sections 232A and 232B in shape of a ring, which are formed on end faces of the inside of the respective base sections 231A and 231B, which project toward the inside thereof, and which are arranged between the outer pipe and the inner pipe so as to define the interval thereof. A recess is formed on a wall face of each of the outer and inner pipe sides of the support sections 232A and 232B. The small and large O-rings 24A, 25A, 24B, and 25B are arranged so as to be inserted in the respective recesses. A through hole 28 for introducing cooling water and a through hole 29 for discharging the cooling water are formed in the respective jacket holders 23A and 23B. When the outer pipe 21 and the inner pipe 22 are arranged so that the support sections 232A and 232B of the jacket holders 23A and 23B may be sandwiched therebetween, a cooling-water circulation space H which is liquid-tightly held by the O-rings between the inner pipe and the outer pipe is formed.

The discharge lamp will be described, referring to FIG. 5. The discharge lamp 10 is a high-output high-pressure mercury lamp or a high-output metal halide lamp, in which a pair of electrodes 13A and 13B, for example, made of tungsten, is disposed so as to face each other, inside a rod shape arc tube 11 made of quartz glass. In the arc tube 11, argon gas is enclosed as electric discharge gas, and mercury is enclosed as light emitting material. In addition, an appropriate amount of metallic compound in addition to the mercury may be filled in the arc tube 11. The full length of the arc tube 11 is 320 mm. The length of the light emission section (namely, the distance between electrodes) is 200 mm. In addition, the diameter of the tube in at least the area of the light emission section in the discharge lamp 10 according to this embodiment does not change, so that it is formed in the shape of a straight pipe.

The electrodes 13A and 13B are made of tungsten, and internal lead rods 14A and 14B, molybdenum foils 15A and 15B, and external lead rods 16A and 16B are connected to the respective electrodes 13A and 13B in that order. The external lead rods are led out to the outside of the arc tube sealing portion, thereby forming electric input part. As shown, for example, in FIG. 5B, the two molybdenum foil 15A and 15B are respectively used, so as to be buried in the sealing portions 12A and 12B. Specifically, these molybdenum foils 15A and 15B are symmetrically arranged on the outer circumferential surface of a support member 19 made of quartz glass, and then the glass tube for the arc tubes is heated from the outer circumference so that the diameter thereof may be made small, whereby the glass tube is airtightly welded to the molybdenum foil 15A and 15B. The quartz glass support member 19 arranged at the center thereof is smaller than the inner diameter of the arc tube 11. For this reason, the diameter of the arc tube gradually becomes smaller toward the outer side thereof in the portions which extend from the light emission section of the arc tube 11 to the sealing portions 12A and 12B. Bases 17 made from ceramics are attached to the respective end portions of the sealing portions 12A and 12B by an adhesive agent M, as shown in FIG. 5A, and then are fixed to and held by the respective lamp holders (30A, 30B) described below.

For example, as shown in FIG. 2 (a plan view), the lamp holders 30A and 30B are in the shape of a disk, part of which is cut out. As shown in FIG. 1, openings 301A and 301B are formed approximately at the center position of the circle of an outer circumference section. The sealing portions 12A and 12B and the bases 17 of the discharge lamp 10 are placed in the openings 301A and 301B, and are fixed with a bolt(s) thereto. In addition, power feeders are pulled out of the respective bases 17 of the discharge lamp 10. The discharge lamp 10 is attached to these lamp holders 30A and 30B, so that the vent holes 32A and 32B for blowing (introducing) cooling air may correspond to upper parts K of the respective shrunk portions 11A and 11B of the arc tube 11.

After this discharge lamp 10 is fixed to one of the lamp holders 30B, as shown in FIG. 3, it is arranged in the lamp configuration space S of the water-cooled jacket 20, and joined and fixed to the jacket holders 23A and 23B, using screws 34 etc. At this time, the lamp holders 30A and 30B are disposed so that vent holes 32A and 32B may turn up and the cut-out portion may turn down. In particular, the vent holes 32A and 32B are arranged so as to be open toward the upper parts (K) of the shrunk portions 11A and 11B of the discharge lamp 10. Moreover, simultaneously, the comparatively large openings 33A and 33B are formed below a tube axis L in the lamp configuration space S. In the present invention, portions which are cooled by the cooling air, are the upper parts K (FIG. 1) in the both shrunk portions 11A and 11B of the arc tube 11. Preferably the cooling air is directly discharged, without passing through other parts. Therefore, it is desirable to form the openings 33A and 33B at least larger than the air distribution openings 31A and 31B, so that the cooling air readily flows out of the lower part of the discharge lamp 10. Moreover, preferably, the openings 33A and 33B are formed below the tube axis L.

As shown in FIG. 1, after the discharge lamp 10 is arranged in the lamp configuration space S of the water-cooled jacket 20, legs 201A and 201B which are attached to a lower part of the ultraviolet ray light source apparatus are fixed to predetermined attachment sections of a processing apparatus. The processing apparatus has a cooling medium supply unit 40 which is made up of a cooling-water supply unit 41 and a cooling air supply unit (compression air equipment) 42 etc. When each insertion section (not shown) is connected to an supply mouth (for example, a water supply inlet) 26, an discharge port 27, or the air distribution openings 31A and 31B, etc., an installation operation will be completed. In addition, the cooling water is specifically demineralized water (pure water).

Here, operational steps of the above-mentioned ultraviolet ray light source apparatus are described below in detail.

The cooling water is introduced and filled up into a cooling-water circulation space H of the water-cooled jacket 20 from the cooling-water supply unit 41. At the time of lamp lighting, the cooling water is supplied at a flow rate of 3-5 liters per minute into the water-cooled jacket 20, and after the cooling water circulates in the cooling-water circulation space H, the cooling water is discharged from the discharge port 27.

The cooling air is supplied in the lamp configuration space S through the air distribution openings 31A and 31B of the lamp holders 30A and 30B from the cooling air supply unit 42. Since the air distribution openings 31A and 31B are open toward the upper part K of the shrunk portions 11A and 11B of the arc tube 11, when the cooling air is introduced into the lamp configuration space S, as shown by the arrow of FIG. 1, the cooling air directly blows and effectively cools the upper part of the shrunk portions at the both ends of the arc tube 11. The flow rate of the cooling air is 5-20 liters per minute, and after contributing to the cooling, the cooling air is discharged to the outside from the openings 33A and 33B formed under the lamp holders 30A and 30B.

Upon lighting of the discharge lamp 10, an electric discharge arc is generated between the electrodes (13A, 13B), so that the tube wall of the arc tube 11 is warmed up with heat thereof. Especially, the upper part thereof becomes high temperature due to the influence of a convection. A gap d between the light emission section area and the inner wall of the water-cooled jacket 20 is set to a predetermined range, for example, 0.5-1.5 mm. The heat of the arc tube 11 conducts in an air layer (gap d), the inner pipe 22, and the cooling water in that order. Since the cooling water flows through and cools the inner pipe 22 during the lamp lighting, the light emission section area of the arc tube 11 is cooled effectively. Although the above-mentioned gap in areas other than the light emission section, i.e., the area of the shrunk portions 11A and 11B, is much larger than that in the light emission section area, so that the cooling effect by the water-cooled jacket 20 is not obtained thereby, since the cooling air is sent toward the upper parts K of the shrunk portions 11A and 11B, these portions are cooled effectively. Moreover, since the cooling air is promptly discharged from the openings 33A and 33B for discharging the cooling air, which are formed in the lower side of the discharge lamp 10, the upper parts K of the shrunk portions 11A and 11B are certainly cooled, so that it is possible to avoid a superfluous temperature rise of the arc tube 11.

Consequently, it is possible to prevent overheating of the entire arc tube, and it is possible to maintain it to a desired temperature, without causing damages or milky spots. And further, electric power to be applied to the lamp can be increased so as to be higher than that of the prior art, and a much larger ultraviolet-ray output can be obtained.

As mentioned above, although the embodiment of the present invention is explained above, the present invention is not limited to the above-mentioned example, and it is possible to make various change thereto. For example, in the structure of the main body of the water-cooled jacket of the above-mentioned example, although separate components, that is, the pipe and the inner pipe are integrated, by using the jacket holder so as to form the flow path of the cooling fluid. The flow path may be formed by welding quartz glass without using the jacket holder, that is, the entire flow path may be formed of quartz glass.

Moreover, although, in this embodiment, the openings for discharging the cooling air are formed by the cut-out portion of the lamp holder, as long as they are located below the inflow mouth or preferably they are located below the tube axis of the lamp, any form may be adopted. In short, the openings are formed so that air flows toward the shrunk portions of the arc tube at the both ends of the lamp, and then the air flows below the inflow mouth.

Moreover, although, in the above example, the high-pressure mercury lamp is described as a discharge lamp. In which the lamp emits ultraviolet rays, and is equipped with an approximately rod shape arc tube, a metal halide lamp may be used therefor. Moreover, the number of the metallic foils buried in each sealing portion of the lamp, or the outer diameter of the sealing portion, etc. can be suitably changed.

Moreover, as long as it transmits light having a desired wavelength(s), cooling medium which flows in the cooling jacket is not limited to water, and appropriate medium can be used therefor.

### Experiments

The ultraviolet ray light source apparatus shown in FIG. 1 was produced in the specification set forth below. In case where the lamp was turned on without sending cooling air, and in a case where cooling air flowed toward the shrunk portions of the arc tube at both ends thereof, the temperature change of the arc tube was measured and the effects of the present invention were confirmed.

### Lamp

In this experiment, a high-pressure mercury lamp having an arc tube made of quartz glass, whose full length was 250 mm, whose outer-diameter was φ30 mm, and whose wall thicknesses was 1.5 mm, was used. Mercury was enclosed inside the arc tube as light-emitting material.

### Water-Cooled Jacket

The outer diameter of an outer pipe of the water-cooled jacket was φ50 mm, the inner diameter thereof was φ 46 mm, the outer diameter of an inner pipe thereof was φ 35 mm, and the inner diameter thereof was φ32 mm. The full length thereof was 250 mm and made of quartz glass. The fluid flow path was filled up with ion-exchange water as cooling fluid, water whose temperature was 25 degrees Celsius was passed therethrough at a flow rate of 3-5 liters per minute. Moreover, the distance d from the inner face of the inner pipe of this water-cooled jacket to the arc tube of the lamp was 0.5 mm.

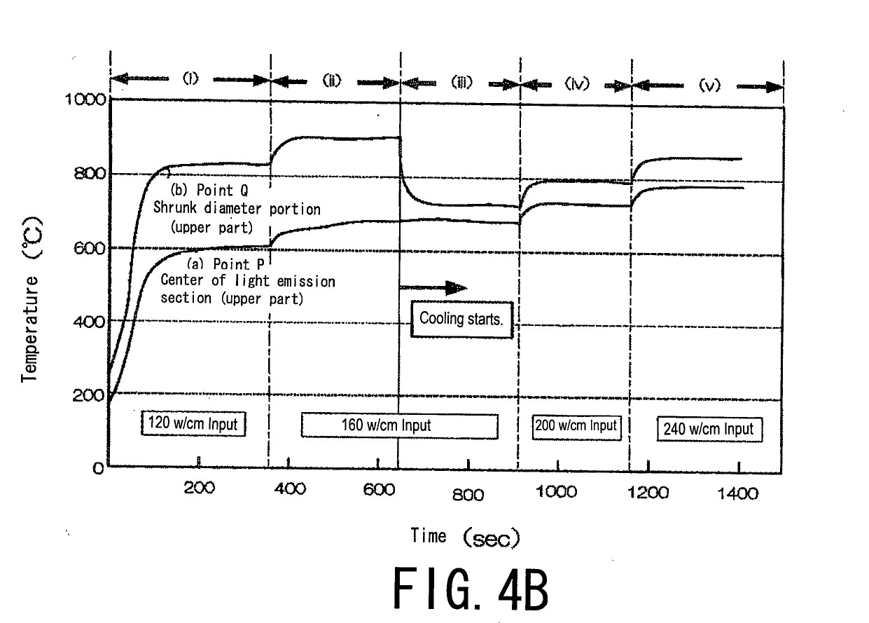

Temperature sensors were set at a center position P in the length direction of the arc tube, and an upper position Q of the shrunk portions, as shown in FIG. 4A. First, in a state where the shrunk portion was not cooled, the input electric power of the lamp was changed to 120-160 W, so as to turn on the lamp, and the temperatures at the points P and Q of the arc tube were measured. Then, a nozzle is directed and set to an upper part of the shrunk portion of the arc tube, and the compressed air which was adjusted in a pressure range of 0.4±0.1 MPa, was sent thereto, as the cooling air, in a condition of 10 liters per minute. And the temperature of the arc tube was measured in the same manner as that of the above experiment. Furthermore, the input electric power of the lamp was changed to 160 W or more, so as to turn on the lamp. In these above cases, by the naked eyes, it was observed whether devitrification of the arc tube, breakage, expansion, etc. would be generated.

### Experimental Result

In FIG. 4B, the temperature changes at the points P and Q of the arc tube respectively, are shown as curves (a) and (b). In addition, the horizontal axis of the figure represents time (s) and the vertical axis thereof represents temperature (degree Celsius).

When the electric power of 120 W/cm was applied to the lamp in a state where cooling was not performed, the temperature at the upper part P of the center of the light emission section was about 600 degrees Celsius. On the other hand, the temperature of the upper part Q at the shrunk portions of the arc tube was about 830 degrees Celsius, so that it was found that the temperature of the upper part Q was 200 degrees Celsius higher than that at the center of the light emission section. The temperatures at the points P and Q were within the range of 500-900 degrees Celsius which were referred to as the suitable temperature range of the arc tube.

(ii) Next, the lamp was turned on under the same conditions as the above (i) except that the electric power to be applied to the lamp was 160 W/cm. Although the temperature at the point P of the arc tube rose to about 650-680 degrees Celsius, cooling by the water-cooled jacket was performed effectively, so that the temperature was sufficiently lower than 900 degrees Celsius which was referred to as the upper limit temperature of the arc tube. On the other hand, the temperature of the point Q of the arc tube already reached 900 degrees Celsius if electric power to be applied to the lamp was raised more than that, there was a possibility that the arc tube would devitrify.

(iii) While electric power to be applied to the lamp which was the same as that in case of (ii) (160 W/cm) was maintained, the compressed air which was adjusted to the pressure range of 0.4±0.1 MPa was supplied towards the upper part of the shrunk portion of the arc tube at the both ends, at a flow rate of 10 liters per minute. The temperature at the point P of the center of the arc tube was about 680 degrees Celsius, so that in the case where the gap between the tube wall of the arc tube and the water-cooled jacket was 0.5 mm or less, it was little-affected by air cooling. However, it turned out that cooling by the water-cooled jacket was performed effectively. On the other hand, after the cooling was started, the temperature of the point Q of the arc tube decreased quickly, and became about 730 degrees Celsius. Since the temperature of the arc tube fell much less than than 900 degrees Celsius, which was referred to as the upper limit, it became possible to increase electric power to be applied to the lamp.

(iv) The lamp was turned on in the same condition as that of the case of (iii), except electric power to be applied to the lamp was 200 W/cm. Although the temperature at the point P of the arc tube rose to about 730 degrees Celsius, cooling by the water-cooled jacket was performed effectively. The temperature was sufficiently lower than 900 degrees Celsius which was referred to as the upper limit temperature of the arc tube. When the lamp input was increased, the temperature of the point Q of the arc tube also rose, so that the temperature thereof reached 730 degrees Celsius. It was possible to further increase electric power to be applied to the lamp while the temperature thereof was much lower than 900 degrees Celsius, which was the upper limit.

(v) The lamp was turned on in the same conditions as that of the case of (iv), except electric power to be applied to the lamp was 240 W/cm. Although the temperature at the point P of the arc tube rose to about 880 degrees Celsius, it was sufficiently lower than the upper limit temperature of 900 degrees Celsius of the arc tube. Moreover, although the temperature of the point Q of the arc tube reached 860 degrees Celsius, as in the above example, it was possible to turn on the lamp without any problems, while the temperature thereof was lower than 900 degrees Celsius.

As in the present invention, if the cooling air is blown towards the upper part of the shrunk portion of the arc tube at the both ends thereof, it is possible to certainly lower the temperature of that part. Further, devitrification of the arc tube can be prevented, and also electric power to be applied to the lamp can be increased more than that of the prior art. Although, in prior art, electric power could be increased to up to 160 W/cm, it is possible to increase it to 240 W/cm in the above-mentioned experiment.

The preceding description has been presented only to illustrate and describe exemplary embodiments of the present ultraviolet ray light source apparatus. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope.

What is claimed is:

1. An ultraviolet ray light source apparatus including a discharge lamp in which a pair of electrodes are arranged inside an approximately rod shape arc tube, and shrunk portions and sealing portions are formed at both ends of the arc tube, a cooling jacket in which a lamp configuration space extending in parallel with the arc tube and is formed in a light emission section area of the discharge lamp, and a pair of lamp holders which supports the discharge lamp in the lamp configuration space, so that an axis of the arc tube is horizontally supported, the ultraviolet ray light source apparatus comprising:
a cooling section which sends cooling air toward an upper part of the shrunk portions; and
a discharge section, provided below at least one of the shrunk portions, which discharges the cooling air.

2. The ultraviolet ray light source apparatus according to claim 1, wherein the cooling section has an air distribution opening formed in the lamp holder so as to be directed to the shrunk portion of the arc tube, and a cooling air supply unit.

3. The ultraviolet ray light source apparatus according to claim 1, wherein the discharge section is an opening formed below one of the lamp holders.

4. The ultraviolet ray light source apparatus according to claim 2, wherein the discharge section is an opening formed below one of the lamp holders.
